(19) United States
(12) Patent Application Publication
(10) Pub. No.: US 2022/0176199 A1
(43) Pub. Date: Jun. 9, 2022

(54) INDOOR WAIST TWISTING MACHINE HAVING ELECTRONIC WEIGHT SCALE

(71) Applicant: Pyeong Soo Kim, Changwon-si (KR)

(72) Inventor: Pyeong Soo Kim, Changwon-si (KR)

(21) Appl. No.: 17/678,606

(22) Filed: Feb. 23, 2022

Related U.S. Application Data
(63) Continuation of application No. PCT/KR2020/010756, filed on Aug. 19, 2020.

(30) Foreign Application Priority Data
Aug. 26, 2019 (KR) 10-2019-0104142

(51) Int. Cl. A63B 22/14; A63B 24/00; A63B 21/005; A63B 21/00; G01G 19/44; G01G 19/52

(52) U.S. Cl. CPC A63B 22/14; A63B 24/0087; A63B 21/0058; A63B 2071/0063; G01G 19/44; G01G 19/52; A63B 2220/833; A63B 21/4033

(57) ABSTRACT

Disclosed is an indoor waist exercise machine having an electronic weight scale. The indoor waist exercise machine having the electronic weight scale according to the embodiment may include an electronic weight scale, a rotary unit installed at a lower side of the electronic weight scale and including a rotary shaft disposed at one end thereof and a rotary sphere disposed at a lower end of the rotary shaft, a support unit installed below the rotary unit, spaced apart from the rotary unit, and having a coupling groove portion, and a control unit configured to control and lower the rotary unit so that the rotary sphere and the coupling groove portion are fitted with each other when a weight detected by the electronic weight scale exceeds a preset critical value.

### CROSS-REFERENCE TO RELATED APPLICATIONS

This application is a continuation of International Application No. PCT/KR2020/010756, filed on Aug. 19, 2020, which claims the benefit of Korean Application No. 10-2019-0104142 filed on Aug. 26, 2019, now Korean Patent No. 10-2234114, granted Mar. 24, 2021, the contents of which are all hereby incorporated by reference herein their entirety.

### Technical Field

The present invention relates to an indoor waist twisting machine having an electronic weight scale, and more particularly, to an indoor waist twisting machine having an electronic weight scale, which has an electronic weight scale function and a waist exercise machine function.

### Background Art

There is an increasing number of patients who suffer from chronic waist pain caused by a change in modern people's life habits in modern society. Therefore, there is increasing interest in waist health, and there is also increasing demand for waist exercise machines used to prevent waist diseases and treat pain.

There are various exercise machines used to prevent waist diseases and treat pain, and the representative exercise machine is a waist twisting exercise machine. A user may relieve waist muscles, which are not used at normal times, by using the waist twisting exercise machine, thereby improving waist health and spine health. However, because the waist twisting exercise machine generally occupies a large space, the waist twisting exercise machine is mainly disposed outdoors, i.e., placed in a small park, a promenade, or the like.

### DISCLOSURE

### Technical Problem

The present invention has been made in an effort to solve the above-mentioned problems, and an object of the present invention is to provide a waist exercise machine having an electronic weight scale, which is miniaturized to be installed indoors.

Another object of the present invention is to provide an indoor waist exercise machine having an electronic weight scale, in which the electronic weight scale and the waist exercise machine are coupled to make a product, thereby maximizing spatial utilization.

Technical problems to be solved by the present invention are not limited to the above-mentioned technical problems, and other technical problems, which are not mentioned above, may be clearly understood from the following descriptions by those skilled in the art to which the present invention pertains.

### Technical Solution

To achieve the above-mentioned objects, an indoor waist twisting machine having an electronic weight scale according to the present invention may include an electronic weight scale, a rotary unit installed at a lower side of the electronic weight scale and including a rotary shaft disposed at one end thereof and a rotary sphere disposed at a lower end of the rotary shaft, a support unit installed below the rotary unit, spaced apart from the rotary unit, and having a coupling groove portion, and a control unit configured to control and lower the rotary unit so that the rotary sphere and the coupling groove portion are fitted with each other when a weight detected by the electronic weight scale exceeds a preset critical value.

In the embodiment, a plurality of rotary balls may be further provided on a lateral surface of the rotary shaft.

In another embodiment, the indoor waist twisting machine having the electronic weight scale may further include an impact absorbing unit positioned between the rotary unit and the support unit.

In still another embodiment, the rotary shaft may further include a rotation motor.

In yet another embodiment, the indoor waist twisting machine having the electronic weight scale may further include a support coupled to one end of the support unit, having a display, and having a handle disposed at the other end thereof

### Advantageous Effects

The indoor waist exercise machine having the electronic weight scale according to the embodiment of the present invention may be miniaturized and make it easy for the user to conveniently take a waist exercise indoors.

The indoor waist exercise machine having the electronic weight scale according to another embodiment of the present invention may maximum the spatial utilization by coupling the electronic weight scale and the waist exercise machine.

The effects of the present invention are not limited to the above-mentioned effects, and other effects, which are not mentioned above, may be clearly understood from the following descriptions by those skilled in the art to which the present invention pertains.

### DESCRIPTION OF DRAWINGS

FIG. 1 is a cross-sectional view of an indoor waist twisting machine having an electronic weight scale according to an embodiment of the present invention.

FIG. 2 is a cross-sectional view for explaining the indoor waist twisting machine having the electronic weight scale when a rotary unit is lowered.

FIG. 3 is a cross-sectional view for explaining the indoor waist twisting machine having the electronic weight scale further having a plurality of rotary balls according to the embodiment of the present invention.

FIG. 4 is an exemplified view of the indoor waist twisting machine having the electronic weight scale further having the plurality of rotary balls according to the embodiment of the present invention.

FIG. 5 is a cross-sectional view for explaining a state in which the rotary unit of the indoor waist twisting machine having the electronic weight scale further having the plurality of rotary balls according to the embodiment of the present invention is lowered.

FIG. 6 is an exemplified view of the indoor waist twisting machine having the electronic weight scale further having a support according to the embodiment of the present invention.

### BEST MODE

Hereinafter, exemplary embodiments of the present invention will be described in detail with reference to the accompanying drawings. Advantages and features of the present invention and methods of achieving the advantages and features will be clear with reference to exemplary embodiments described in detail below together with the accompanying drawings. However, the present invention is not limited to the embodiments disclosed herein but will be implemented in various forms. The embodiments of the present invention are provided so that the present invention is completely disclosed, and a person with ordinary skill in the art can fully understand the scope of the present invention. the present invention will be defined only by the scope of the appended claims. Throughout the specification, the same reference numerals denote the same constituent elements.

Unless otherwise defined, all terms (including technical and scientific terms) used in the present specification may be used as the meaning which may be commonly understood by the person with ordinary skill in the art, to which the present invention belongs. In addition, terms defined in a generally used dictionary shall not be construed in ideal or excessively formal meanings unless they are clearly and specially defined in the present specification. The terms used in the present specification are for explaining the exemplary embodiments, not for limiting the present invention. Unless particularly stated otherwise in the present specification, a singular form also includes a plural form.

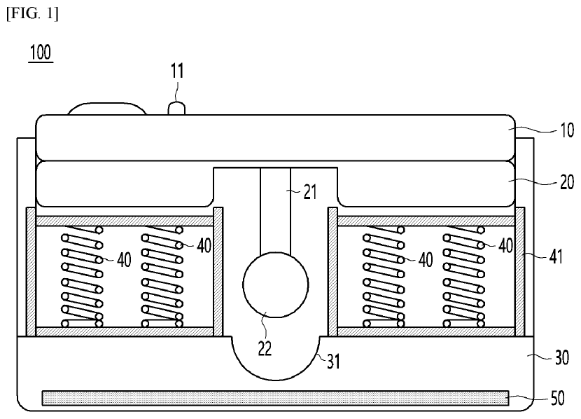

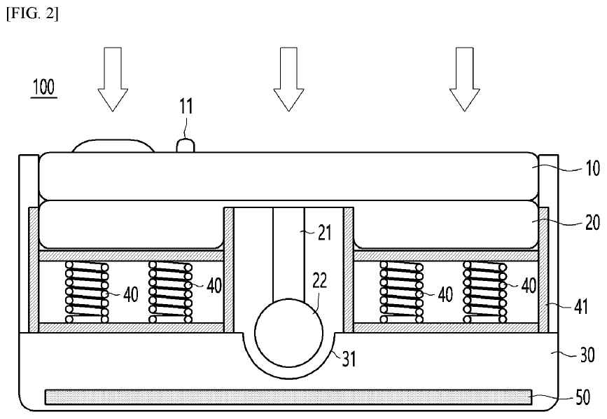

FIG. 1 is a cross-sectional view of an indoor waist twisting machine having an electronic weight scale according to an embodiment of the present invention. FIG. 2 is a cross-sectional view for explaining the indoor waist twisting machine having the electronic weight scale when a rotary unit is lowered.

Referring to FIGS. 1 and 2, an indoor waist twisting machine 100 having an electronic weight scale according to an embodiment of the present invention may include an electronic weight scale 10, a rotary unit 20, a support unit 30, an impact absorbing unit 40, and a control unit 50.

The electronic weight scale 10 serves to detect a user's weight. According to the embodiment, the electronic weight scale 10 may measure the user's weight by using a weight detection sensor disposed in the electronic weight scale 10 and display the weight on a screen disposed on the electronic weight scale 10.

The rotary unit 20 may be disposed at a lower side of the electronic weight scale 10 and rotate together with the electronic weight scale 10.

In the embodiment, a rotary shaft 21 may be disposed at one end of the rotary unit 20. The rotary shaft 21 serves as a central shaft when the rotary unit 20 rotates.

A rotary sphere 22 may be disposed at a lower end of the rotary shaft 21. The rotary sphere 22 is prepared in a rotatable state when the rotary sphere 22 is fitted with a coupling groove portion 31 to be described below. When the rotary sphere 22 is fitted with the coupling groove portion 31 and rotated, the rotary unit 20 rotates about the rotary shaft 21.

In another embodiment, a rotation motor may be further provided in the rotary shaft 21. In particular, the rotation motor may have a rotation driving shaft configured to be rotated by power. The rotation driving shaft may be inserted and fixed into the rotary shaft 21 so that the rotary sphere 22 of the rotary unit 20 rotates about the rotary shaft 21. As a result, when a rotation driving unit of the rotation motor is rotated by power, the rotary shaft 21 may also rotate, and the rotary sphere 22 disposed at the lower end of the rotary shaft 21 may also rotate. The rotation motor may operate in response to the request of the control unit 50 to be described below. The rotation generated by the rotation motor provided in the rotary shaft 21 may rotate the rotary sphere 22 disposed at the lower end of the rotary shaft 21. Therefore, when the rotation motor operates, the rotation generated by the rotation motor may assist a force for taking a waist exercise when the user takes an exercise using the indoor waist twisting machine 100 having the electronic weight scale.

In still another embodiment, in the case in which the rotation motor is further provided in the rotary shaft 21, an input unit 11 configured to receive a rotational speed may be further provided. The input unit 11 may be installed in the electronic weight scale. The input unit 11 may be a button-type input unit, a touch-type input unit, or any type of input unit well known in the technical field of the present invention.

The support unit 30 may be installed below the rotary unit 20 and spaced apart from the rotary unit 20. The support unit 30 may have the coupling groove portion 31.

In the embodiment, the support unit 30 may be provided in the form of a housing configured to accommodate other components of the indoor waist twisting machine 100 having the electronic weight scale.

The coupling groove portion 31 may be formed in a front surface of the support unit 30 so that the coupling groove portion 31 may be fitted with the rotary sphere 22. Therefore, the coupling groove portion 31 may have a hemispheric debossed shape.

The impact absorbing unit 40 is positioned between the rotary unit 20 and the support unit 30 and serves to absorb impact (i.e., external force in the gravitational direction) due to the user's weight when the rotary unit 20 is lowered. In more detail, the impact absorbing unit 40 absorbs impact due to the user's weight when the rotary sphere 22 comes into contact with the coupling groove portion 31 as the rotary unit 20 is lowered.

The impact absorbing unit 40 may be made of, but not necessarily limited to, at least one selected from a group consisting of a metal spring, a rubber spring, gel, and oil.

In the embodiment, the impact absorbing unit 40 may be positioned in an inner support 41. The inner support 41 may be positioned between the rotary unit 20 and the support unit 30 and have vertical and horizontal shapes. An upper portion of the inner support 41, which supports the support unit, may be lowered by the external force in the gravitational direction. The inner support 41 may protect the impact absorbing unit 40 and make it easy to lower the rotary unit 20. In addition, the inner support 41 is positioned between the rotary unit 20 and the impact absorbing unit 40, such that a space is divided. Therefore, the rotary unit may be easily rotated after the rotary unit 20 is lowered.

The control unit 50 controls an overall operation of the indoor waist twisting machine 100 having the electronic weight scale according to the embodiment of the present invention. The control unit 50 may process signals, data, information, and the like inputted or outputted through the above-mentioned components and a display unit to be described below. To this end, the control unit 50 may include one or more processors.

The control unit 50 may include a central processing unit (CPU), a microprocessor unit (MPU), a microcontroller unit (MCU), and any type of processor well known in the technical field of the present invention. The control unit 50 may include a memory, for example, a RAM. In addition, the control unit 50 may store one or more application programs for performing a method of controlling the indoor waist twisting machine 100 having the electronic weight scale according to the embodiment of the present invention. The control unit 50 may provide the user with appropriate information or functions or process the information or functions by executing the one or more application programs.

The control unit 50 may control and lower the rotary unit 20 when the weight detected by the electronic weight scale 10 exceeds a preset critical value. Alternatively, the upper portion of the inner support 41 may be lowered as a volume of the impact absorbing unit 40 is decreased by the external force (i.e., the user's weight) applied in the gravitational direction. When the rotary unit 20 is lowered, the rotary sphere 22 disposed at the lower end of the rotary shaft 21 of the rotary unit 20 is lowered, such that the rotary sphere 22 may be prepared in a state in which the rotary sphere 22 is rotatable by being fitted with the coupling groove portion 31 of the support unit 30.

The setting of the critical value for controlling the lowering of the rotary unit 20 may be stored in advance in the control unit 50.

In another embodiment, in the case in which the rotation motor is further provided in the rotary shaft 21, and the rotation motor may operate in response to the request of the control unit 50. In addition, in the case in which the input unit 11 configured to receive the speed of the rotation motor is further provided, the control unit 50 may control the speed of the rotation motor on the basis of the received speed.

While the configuration of the indoor waist twisting machine 100 having the electronic weight scale having the impact absorbing unit 40 and the input unit 11 has been described, but the present invention is not necessarily limited thereto, and the impact absorbing unit 40 and the input unit 11 may be omitted.

### Mode for Invention

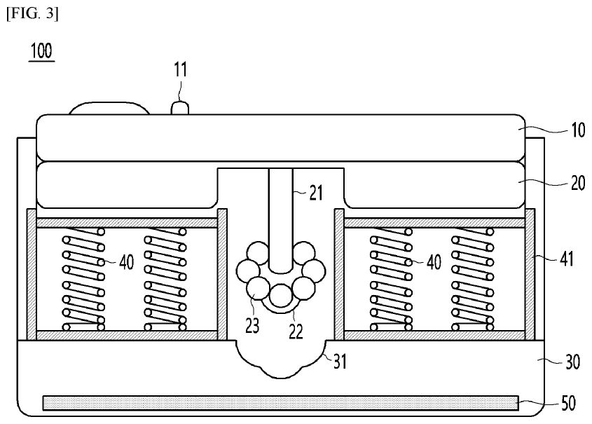

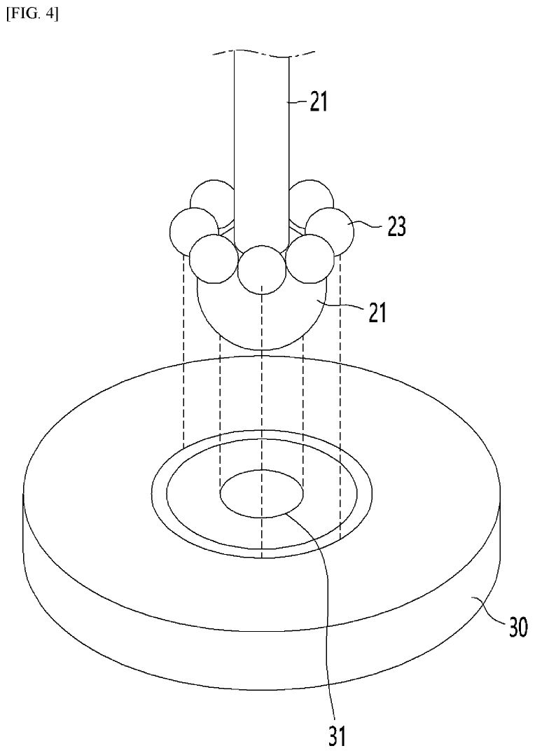

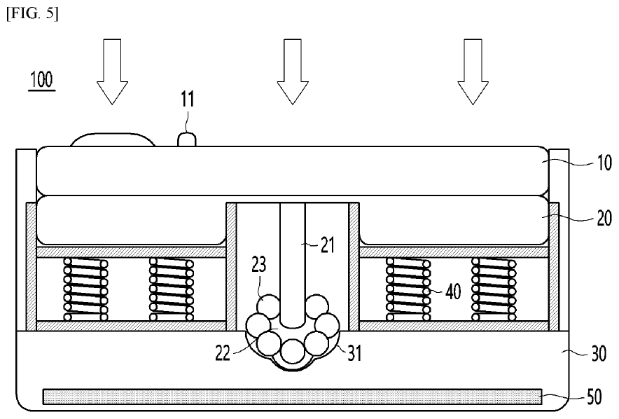

FIG. 3 is a cross-sectional view for explaining the indoor waist twisting machine having the electronic weight scale further having a plurality of rotary balls according to the embodiment of the present invention. FIG. 4 is an exemplified view of the indoor waist twisting machine having the electronic weight scale further having the plurality of rotary balls according to the embodiment of the present invention. FIG. 5 is a cross-sectional view for explaining a state in which the rotary unit of the indoor waist twisting machine having the electronic weight scale further having the plurality of rotary balls according to the embodiment of the present invention is lowered.

Referring to FIGS. 3 to 5, the indoor waist twisting machine 100 having the electronic weight scale according to the embodiment of the present invention may further include a plurality of rotary balls 23 disposed on a lateral surface of the rotary shaft 21.

In the case in which the plurality of rotary balls 23 is further provided, the coupling groove portion 31 may have a debossed shape so that the rotary sphere 22 and the rotary balls 23 may be in contact with the coupling groove portion 31 and rotated. In more detail, the coupling groove portion 31 may have a hemispheric debossed shape so as to be fitted with the rotary sphere 22, and a debossed passageway for the rotary balls 23 may be formed around the hemispheric debossed shape.

Therefore, when the rotary unit 20 is lowered by the control unit 50, the rotary sphere 22 and the rotary balls 23 are fitted with the coupling groove portion 31 and thus prepared in a rotatable state. When the rotary unit 20 is rotated by the user's force, the rotary balls 23 may assist the rotation of the rotary sphere 22.

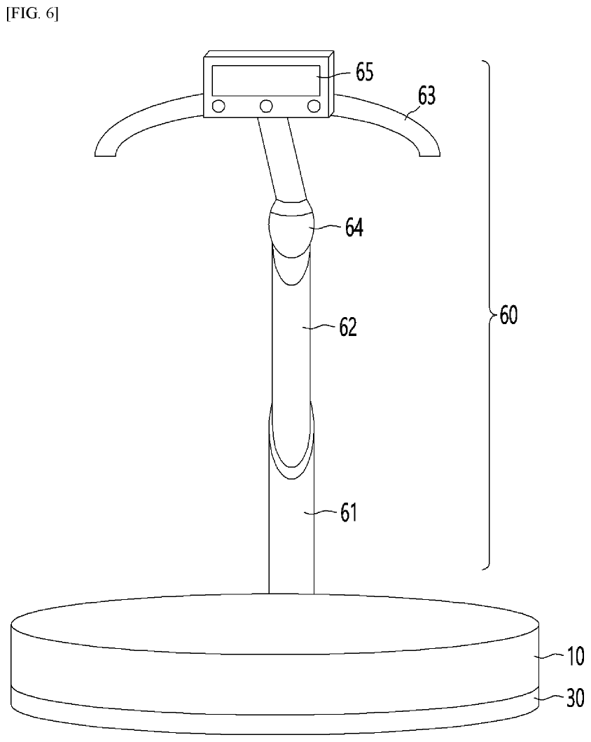

FIG. 6 is an exemplified view of the indoor waist twisting machine having the electronic weight scale further having a support according to the embodiment of the present invention.

Referring to FIG. 6, a support 60 may be coupled to one end of the support unit 30. The user may take an exercise while easily maintaining the balance by using the support 60 while taking the exercise using the indoor waist twisting machine 100 having the electronic weight scale. In addition, the user may more easily maintain the balance by using a handle 63 disposed at one end of the support 60.

In the embodiment, a display 65 may be disposed at one end of the support 60. Numerical values such as the user's rotational speed or the number of rotations may be outputted through the display 65 under the control of the control unit 50.

The user's weight measured by the electronic weight scale 10 may be displayed on the display 65.

In the embodiment, the support 60 may include a first support rod 61 coupled to one end of the support unit 30, and a second support rod 62 having the display and the handle 63 disposed at the other end thereof. The second support rod 62 may be inserted into the first support rod 61. Therefore, the user may adjust a length of the support 60 by inserting the second support rod 62 into the first support rod 61. Therefore, the user may use the support 60 while adjusting the length of the support 60 in accordance with the user's height.

In the embodiment, the second support rod 62 further has a hinge 64, and the handle 63 is coupled to the hinge 64, such that an angle of the handle 63 may be adjusted by means of the hinge 64. Therefore, the user may easily take the waist exercise while adjusting the angle of the handle 63.

While the exemplary embodiments of the present invention have been described with reference to the accompanying drawings, those skilled in the art will understand that the present invention may be carried out in any other specific form without changing the technical spirit or an essential feature thereof. Therefore, it should be understood that the above-described exemplary embodiments are illustrative in all aspects and do not limit the present invention.

### INDUSTRIAL APPLICABILITY

The present invention relates to the indoor waist twisting machine having the electronic weight scale and may be applied to health care industries.

1. An indoor waist twisting machine having an electronic weight scale, the indoor waist twisting machine comprising:
an electronic weight scale;
a rotary unit installed at a lower side of the electronic weight scale and comprising a rotary shaft disposed at one end thereof and a rotary sphere disposed at a lower end of the rotary shaft;
a rotation motor comprising a rotation driving shaft configured to be rotated by power, the rotation driving shaft being inserted into the rotary shaft so that the rotary sphere rotates about the rotary shaft;
a support unit installed below the rotary unit, spaced apart from the rotary unit, and having a coupling groove portion;
an inner support positioned between the rotary unit and the support unit, wherein an upper portion of the inner support, which is configured to support the support unit, is configured to be lowered by an external force in a gravitational direction;
an impact absorbing unit disposed inside the inner support and configured to absorb impact caused by the external force; and
a control unit configured to control the rotation motor to rotate the rotation driving shaft of the rotation motor when the rotary sphere and the coupling groove portion are fitted with each other as the upper portion of the inner support is lowered by the external force.

2. The indoor waist twisting machine of claim 1, further comprising:
a plurality of rotary balls disposed on a lateral surface of the rotary shaft.

3. The indoor waist twisting machine of claim 1, wherein the impact absorbing unit is made of at least one selected from a group consisting of a metal spring, a rubber spring, gel, and oil.

4. The indoor waist twisting machine of claim 1, further comprising:
an input unit configured to receive a rotational speed,
wherein the control unit controls a rotational speed of the rotation motor on the basis of the received speed.

5. The indoor waist twisting machine of claim 1, further comprising:
a support coupled to one end of the support unit, having a display, and having a handle disposed at the other end thereof,
wherein the support is attachable and detachable.

6. The indoor waist twisting machine of claim 5, wherein the control unit performs control to display the number of rotations on the display.

7. The indoor waist twisting machine of claim 5, wherein the support comprises:
a first support rod coupled to one end of the support unit; and
a second support rod having the display and the handle disposed at the other end thereof, and
wherein the second support rod is inserted into the first support rod.

8. The indoor waist twisting machine of claim 7, further comprising:
a hinge disposed at one end of the second support rod,
wherein the handle is coupled to the hinge, and an angle of the handle is adjusted by means of the hinge.
